(19) United States
(12) Patent Application Publication
(10) Pub. No.: US 2017/0312870 A1
(43) Pub. Date: Nov. 2, 2017

(54) PROCESS FOR MANUFACTURING A PIECE HAVING A RELATIVELY BIG SIZE, IN PARTICULAR FOR MANUFACTURING A BLADE FOR A TURBINE ENGINE

(71) Applicant: GE AVIO S.R.L., Rivalta Di Torino (IT)

(72) Inventor: Mauro VARETTI, Collegno (IT)

(21) Appl. No.: 15/524,809

(22) PCT Filed: Nov. 6, 2015
(86) PCT No.: PCT/IB2015/058591

§ 371 Date: May 5, 2017

(30) Foreign Application Priority Data
Nov. 7, 2014 (IT) TO2014A000926

(51) Int. Cl. B23P 15/04; F01D 5/14

(52) U.S. Cl. CPC B23P 15/04; F01D 5/147; F05D 2220/32; F05D 2230/51; F05D 2230/31

(57) ABSTRACT

According to a process for manufacturing a piece having a relatively big size, in particular a blade for a turbine engine, at least two sectors are manufactured separately from each another, so that each of them comprises: a portion having substantially the same shape and size of a corresponding portion of the piece to be made, at least one coupling surface which is complementary to a corresponding coupling surface of the other sector, and a continuous outer flange at each of said coupling surfaces; the sectors are rested against each other at the coupling surfaces and are then fastened to each other by means of an electron beam welding, carried out under vacuum, so as to weld the outer flanges along the entire outer perimeter of the coupling surfaces, and by means of a subsequent hot isostatic compression; after the fastening, the flanges are removed by means of a material removal machining.

### TECHNICAL FIELD

The present invention relates to a process for manufacturing a piece having a relatively big size, in particular for manufacturing a blade for a turbine engine.

### BACKGROUND ART

As it is known, for the manufacturing of pieces, even in the aeronautical field, additive fabrication techniques are used more and more frequently. These techniques involve the repetition of cycles, during which successive horizontal sections of the component to be made are formed. In particular, at the beginning of each cycle, a powder layer is deposited. Such layer has a substantially constant thickness and is made of powder that has the same composition as the piece to be made. Afterwards, specific areas of the powder layer are melted through the scanning of a focused energy beam, usually a laser beam or an electron beam. These areas are selected on the basis of a mathematical model, which represents the geometry and the sizes of the piece to be made. In other words, in those areas where the powder is melted, a continuous structure is formed, which defines a corresponding horizontal section of the component.

Once the melting has ended, the part of the piece that has already been formed is lowered to an extent that equals the thickness of the powder layer that is deposited every time, so as to move on to the next cycle. Finally, once all cycles have ended, residual powder is removed.

Powder is melted inside working chambers with the shape of a cylinder or a parallelepiped, which usually have maximum sizes that are relatively small, up to a few dozen centimetres per side. Therefore, pieces can be made which, in turn, have a maximum size that is smaller than the one of the working chamber.

In order to overcome this drawback, the piece can be made by firstly manufacturing a plurality of distinct components or sectors and by then fastening these components to each other. For example, in order to manufacture the components of a piece integral to each other, it is possible to use welding processes, welding-brazing processes and or fastening processes involving mechanical elements.

However, these fastening methods are not satisfactory. In particular, welding tends to locally alter the mechanical properties of the material used and to generate defects in the final piece; brazing has use limits, which are determined by the filler material used; and fastening by means of mechanical elements can cause an increase in the weight and in stresses concentrated in the joint areas of the final piece.

### DISCLOSURE OF INVENTION

The object of the present invention is to provide a process for manufacturing a piece having a relatively big size, in particular for manufacturing a blade for a turbine engine, which can solve the problems discussed above in a simple and cost-effective manner.

According to the present invention, there is provided a process for manufacturing a piece having a relatively big size, in particular for manufacturing a blade for a turbine engine, as defined in claim 1.

### BRIEF DESCRIPTION OF THE DRAWINGS

The present invention will be best understood upon perusal of the following detailed description of a preferred embodiment, which is provided by way of example and is not limiting, with reference to the accompanying drawings, in which:

FIG. 1 is a simplified side view of a piece having a relatively big size, in particular a blade for a turbine engine, manufactured according to a preferred embodiment of the process of the present invention;

FIG. 2 is a diagram showing a sequence of steps of the process according to the present invention; and

FIG. 3 is similar to FIG. 1 ans shows how a blank of the blade is made, in an intermediate step of the process according to the present invention.

### BEST MODE FOR CARRYING OUT THE INVENTION

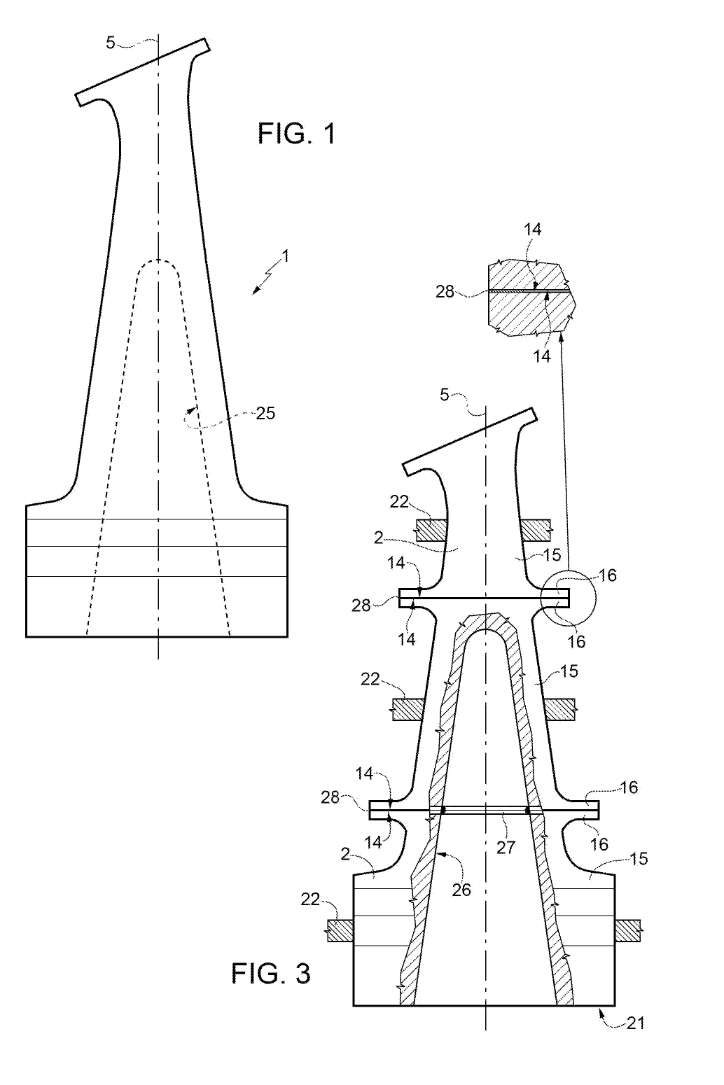

In FIG. 1, reference number 1 indicates a piece having a relatively big size and made by combining at least two sectors 2 with each other (FIG. 3). In the example shown, the piece is made up of three sectors 2.

Preferably, the piece 1 made with the process according to the present invention is defined by a blade for a turbine engine, elongated along an axis 5. The sectors 2, when they are combined with each other during the process, are aligned along the axis 5 and will then define, respectively, two opposite end portions and an intermediate portion of the blade 1.

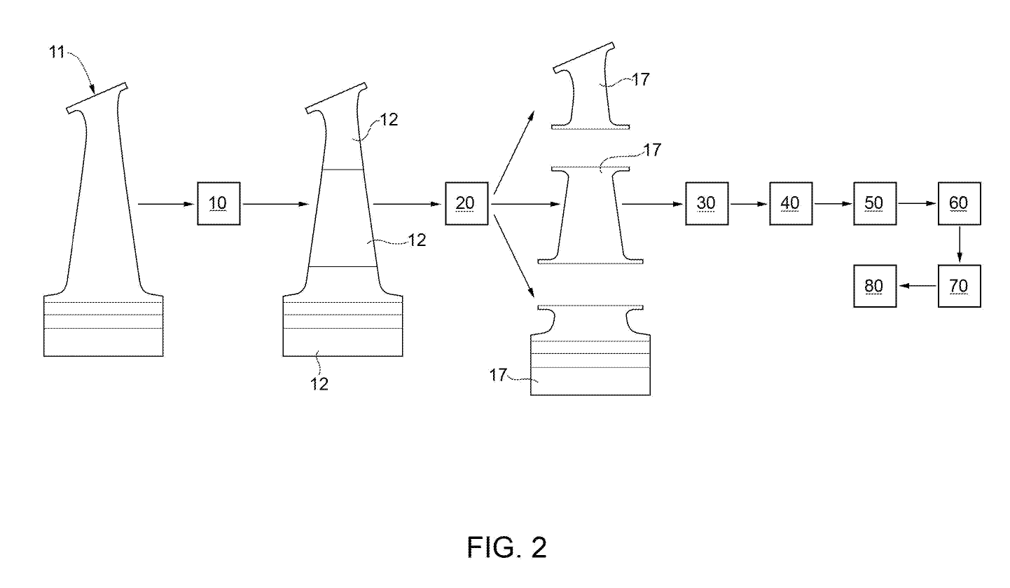

With reference to FIG. 2, when designing the piece 1, you obtain a model or drawing 11, which is then divided into different portions 12 (block 10) respectively corresponding to the sectors 2 to be combined. This division of the model 11 is carried out in such a way that the sizes of each portion 12 are relatively small, so as to be able to manufacture each one of the corresponding sectors 2 in a relatively simple manner.

The division of the model 11 is carried out in such a way that the separating surfaces between the portions 12 are defined by surfaces that are complementary to each other, are transverse to the axis 5, coincide with the respective faces 14 delimiting the ends of the sectors 2 (FIG. 3) and are preferably flat.

The sectors 2 are designed (block 20) by setting their shape and their sizes on the basis of the ones of the corresponding portions 12, which were previously defined. More precisely, with reference to FIG. 3, besides the faces 14, each sector 2 is designed so as to comprise a portion 15 having the same shape and substantially the same size as the corresponding portion 12, and an end flange 16 arranged in the area of each face 14.

The sizes set for the portion 15 during the designing phase can be slightly larger than the ones of the portion 12, so as to provide a machining allowance, whose extent is determined during the designing phase as a function of the expected size variations that will occur during the subsequent steps of the process.

As far as the flanges are concerned 16, they radially project outwards relative to the axial ends of the portion 15 and, preferably, they are continuous around the portion 15, namely in a circumferential direction about the axis 5.

The step of block 20, during which the sectors 2 are designed, is carried out so as to obtain respective three-dimensional mathematical models 17, which are then used to manufacture the sectors 2 (block 30), preferably by means of additive fabrication techniques, namely “layer by layer” fabrication techniques, such as “Direct Laser Forming” (DLF), “Direct Metal Laser Sintering” (DMLS), “Selective Laser Melting” (SLM), or “Electron Beam Melting” (EBM). These techniques use, as raw materials, powders having the same composition as the end product to be obtained (for example a metal alloy of TiAl) and they are not described in detail herein, as they belong to the state of art. In any case, in order to obtain the sectors 2, it is also possible to use manufacturing techniques other than the ones operating “layer by layer” (e.g. moulding techniques).

After having been built, the sectors 2 are combined or assembled together (block 40) by placing the faces 14 in such a way that they rest against one another along the axis 5, as you can see in FIG. 3, thus forming a single blank 21, which obviously has a shape that is similar to the one of the blade 1 to be obtained in the end.

In particular, the blank 21 is formed by arranging the sectors 2 in a template 22 (partially shown, in a simplified manner, in FIG. 3). The template 22 is provided with holding devices, which are not described in detail and are configured so as to hold the sectors 2 in relative fixed positions. Preferably, the template 22 is provided with reference systems, which are not described in detail and are configured to precisely define the positions in which to place the sectors 2, so as to form the blank 21 in a relatively simple and quick manner.

In the example shown in FIGS. 1 and 3, the blade 1 has an inner cavity 25, which is accessible through an axial end and, in the blank 21, is defined by a surface 26 intersected by the faces 14. Preferably, the blank 21 is subject to a brazing operation (block 50), preferably under vacuum, so as to form a continuous brazing bead 27 (shown not to scale) on the surface 26 in the area of the inner perimeter of the faces 14, so as to isolate the cavity 25 from the faces 14 themselves.

Then, the blank 21 is subject to an electron beam welding, also known as EBW, so as to weld the pairs of flanges 16 to each other along the entire outer perimeter of 28 of the faces 14 (block 60). The electron beam welding technique is always carried out in a vacuum environment. If necessary, other welding techniques (e.g. laser techniques) can possibly be used, which would normally not require this condition; however, according to the present invention the outer perimeter 28 is welded under vacuum.

In particular, the two welding operations (brazing and electron beam welding) are carried out in the same chamber (not shown) so as to keep the vacuum environment unaltered.

In some cases, the electron beam welding operation can be proceeded by a pre-heating step, which is preferably obtained by means of the same electron beam.

At the end of the electron beam welding operation, the sectors 2 are firmly connected. Since the welding is carried out under vacuum, even in the space or meatus existing between the faces 14 there is a vacuum environment, even if the blank 21 were to be moved to the outside. With this operation, therefore, we can guarantee the tight sealing of the meatus between the faces 14.

At this point (block 70), the blank 21 undergoes an operation known as hot isostatic pressing or HIP. This operation causes not only the compression of the material on the inside of each previously manufactured sector 2, but also the diffusion welding of the material in the area of the interface or meatus between the portions 15, namely in the areas of the faces 14 that are arranged more on the inside compared to the flanges 16 where the EBW welding step was previously carried out. This diffusion welding is especially possible thanks to the vacuum that was previously obtained in the aforesaid meatus.

Subsequently, the blank 21 is subject to a material removal machining operation, in particular a milling operation (block 80), to remove the flanges 16 and generate the final profile of the blade 1 in the joint areas. During this machining step, therefore, the portions 15 are left unaltered. The brazing bead 27 can be removed or it can be kept, as a function of the specific operating requirements of the piece 1.

At the end of this step, the desired blade 1 is obtained, which is shown in FIG. 1.

Owing to the above, the process described above can clearly allow operators to manufacture pieces having a relatively small size by connecting different sectors 2 to each other by means of the HIP compression step, which would have been used anyway to compress the material on the inside of the sectors 2. The size limit for the piece 1 to be manufactured is not determined by the additive fabrication machines used in block 30 to manufacture the sectors 2, but it is determined by the plant used in block 60 to carry out the HIP compression step.

Furthermore, in the joining areas between the portions 15 of the sectors 2 there are no metallurgic alterations and/or defects, as HIP compression allows the sectors 2 to be joined in a continuous and homogeneous manner, since you automatically obtain a diffusion welding of the material of the two portions 15. At the same time, the removal of the flanges 16 allows you to eliminate possible defects that may have been generated by the EBW welding operation carried out along the perimeter 28.

Finally, it is clear that the process described with reference to the accompanying drawings can be subject to changes and variations, without for this reason going beyond the scope of protection of the present invention, as defined in the appended claims.

In particular, as already mentioned above, the brazing step of block 50 is absent if the piece 1 does not have any cavity opening up outwards; and/or brazing could be replaced by a different welding technique; and/or the sectors 2 can be manufactured in block 30 in a way other than the one discussed above by way of example; and/or the faces 14 could be defined by coupling surfaces that are not flat and/or are not orthogonal to the axis 5.

1. A process for manufacturing a piece having a relatively big size, in particular for manufacturing a blade for a turbine engine; the process comprising the steps of:
manufacturing, separately from each another, at least two sectors (2) so that each of said sectors (2) comprises:
a) a portion (15) having substantially the same shape and size of a corresponding portion of said piece;
b) at least one coupling surface (14) which is complementary to a corresponding coupling surface of another sector (2);
forming a blank (21) by resting the fabricated sectors (2) against each other at said coupling surfaces (14);
fastening the sectors (2) to each another;
characterized in that
the fabrication step is carried out such that each said sector (2) further comprises an outer flange (16) at each of said coupling surfaces (14); each of said outer flanges (16) being continuous around the respective portion (15);
the fastening step comprises the following operations:
a) a welding carried out under vacuum and so as to weld the outer flanges (16) to each another along the entire outer perimeter of said coupling surfaces (14);
b) a hot isostatic compression, after said vacuum welding;
and characterized by further comprising a material removal machining step, carried out so as to remove said outer flanges (16), after said fastening step.

2. A process according to claim 1, characterized in that said vacuum welding is an electron beam welding.

3. A process according to claim 1, characterized in that said blank (21) has an inner cavity (25) intersected by said coupling surfaces (14), and in that said fastening step comprises a further welding operation, which is carried out so as to weld said portions (15) along the entire inner perimeter of said coupling surfaces.

4. A process according to claim 3, characterized in that said further welding operation is defined by a brazing.

5. A process according to claim 1, characterized in that said fabrication step is defined by an additive fabrication process.

6. A process according to claim 1, characterized in that said blank (21) is formed by arranging said sectors (2) in a template (22); at least part of said fastening step being carried out while said sectors (2) are kept in relatively fixed positions by said template (22).
